(19) United States
(12) Patent Application Publication
(10) Pub. No.: US 2008/0071735 A1
(43) Pub. Date: Mar. 20, 2008

(54) METHOD, APPARATUS, AND COMPUTER PROGAM PRODUCT FOR DATA TRANSFORMATION

(75) Inventors: ROY B. HARRISON, Andover (GB); MICHAEL J. A. JOHNSON, Awbridge (GB)

Correspondence Address: IBM CORPORATION, 3039 CORNWALLIS RD., DEPT. T81 / B503, PO BOX 12195, REASEARCH TRIANGLE PARK, NC, 27709, US

(73) Assignee: INTERNATIONAL BUSINESS MACHINES CORPORATION, Armonk, NY (US)

(21) Appl. No.: 11/469,914

(22) Filed: Sep. 5, 2006

(51) Int. Cl. G06F 17/30

(52) U.S. Cl. 707/3

(57) ABSTRACT

Method, apparatus and computer program product for data transformation. A message is received and transformed into an input tree of elements, each element having a value associated therewith. At least one transformation expression is issued against the input tree in order to create an output tree of elements having values associated therewith. The output tree of elements may then be serialized into a message for forward transmission. The creation of the output tree of elements uses the contents of the at least one transformation expression to determine when an element needs to be created in the output tree.

### FIELD OF THE INVENTION

The present invention relates to the field of data transformation.

### BACKGROUND

Messaging systems are well known in the art. One such system is IBM's WebSphere® MQ (IBM and WebSphere are trademarks of International Business Machines Corporation in the United States, other countries, or both).

FIG. 1 provides an overview of how such a system operates. System 10 executes programs 30 and 40. System 20 executes program 50. These programs communicate with queues 80; Q1; Q2 running on queue managers 70 or 90 via a message queuing interface (MQI) 60. For example, program 30 may wish to put a message to Q1 for retrieval by program 40. The program puts this request to its local queue manager 70 which immediately knows where Q1 is because it manages that queue. Thus the message can be put straight to Q1. On the other hand, program 30 (running in system 10) may wish to put a message to Q2 (running in system 20) for retrieval by program 50. In this instance Q2 is not local to the program's local queue manager 70. When it receives a request to put to Q2, queue manager 70 will look for a local definition of the remote queue (i.e. a point to Q2). Having found the local definition, the message is put to TransmitQ data 80 for transfer via channel 85 to Q2 managed by queue manager 90. Once the message arrives at Q2, it is available for retrieval by program 50.

Thus produces such as IBM® WebSphere MQ provide the base mechanism via which messages can be transported. For more advanced data manipulation (transformation), it is necessary to use a product such as IBM's WebSphere Message Broker. Using such a product it is possible to execute database-like expressions (e.g. SQL SELECT statements) against incoming messages in order to create appropriate output messages for forward transmission or to perform additional data transformation. Data is manipulated in the form of input and output trees. Information is extracted from each received message to create an input tree of elements, with each element being assigned a value. A database-like expression is then executed against such an input tree in order to build an output tree of elements having a new structure and values. The creation of such an output tree can be processor intensive as it is necessary to determine for each element whether it already exists in the output tree. If so, it is necessary to navigate to that element and if not, the element must be created. Such processing occurs at runtime for each newly received message and messages can be extremely complex with multiple repeating elements. For example, a message may contain a long list of items, each having many values (e.g. part number, cost). Creating such output trees repeatedly can consume large amounts of CPU time.

### SUMMARY

According to a first aspect, there is provided a method for data transformation comprising: receiving a message; transforming the message into an input tree of elements, each element having a value associated therewith; and issuing at least one transformation expression against the input tree in order to create an output tree of elements having values associated therewith. Here, the creation of the output tree of elements comprises using the contents of the at least one transformation expression to determine when an element needs to be created in the output tree.

By way of example, a transformation expression may be a database-like expression.

In a preferred embodiment, a transformation expression comprises a plurality of elements which map to output elements in the output tree.

In a preferred embodiment, the elements which map to output elements in the output tree are analyzed for each of a plurality of transformation expressions. The first occurrence of each unique element within the plurality of transformation expressions is then marked.

Preferably it is determined that an output element needs to be created in the output tree when such an element results from the first occurrence of a unique element within the plurality of transformation expressions.

Preferably it is determined that an output element will already existing the output tree when such an element results from a subsequent occurrence of a unique element within the plurality of transformation expressions.

Preferably, responsive to determining that an output element needs to be created in the output tree, the output element is created.

In one embodiment, responsive to determining that an output element does not need to be created in the output tree, the output element is navigated to by tree traversal.

In one embodiment, responsive to determining that an output element does not need to be created in the output tree, the element is accessed by reference.

According to a second aspect, there is provided an apparatus for data transformation comprising: a receiving component for receiving a message; a transforming component for transforming the message into an input tree of elements, each element have a value associated therewith; and an issuing component for issuing at least one transformation expression against the input tree in order to create an output tree of elements having values associated therewith, the creation of the output tree of elements comprising being via a using component for using the contents of the at least one transformation expression to determine when an element needs to be created in the output tree.

According to third aspect, there is provided a computer program product comprising a computer-usable medium including computer-usable program code for data transformation. The computer program product includes: computer-usable code for receiving a message; computer-usable program code for transforming the message into an input tree of elements, each element having a value associated therewith; and computer-usable code for issuing at least one transformation expression against the input tree in order to create an output tree of elements having values associated therewith. The creation of the output tree of elements may be via computer-usable code for using the contents of the at least one transformation expression to determine when an element needs to be created in the output tree.

### BRIEF DESCRIPTION OF THE DRAWINGS

A preferred embodiment of the present invention will now be described, by way of example only, with reference to the following drawings, wherein:

FIGS. 1, 2a, 2b, and 2c illustrate messaging systems according to the prior art; and

FIGS. 3a, 3b, 3c, 3d, and 3e illustrate the componentry and processing of a messaging system in accordance with a preferred embodiment of the present invention.

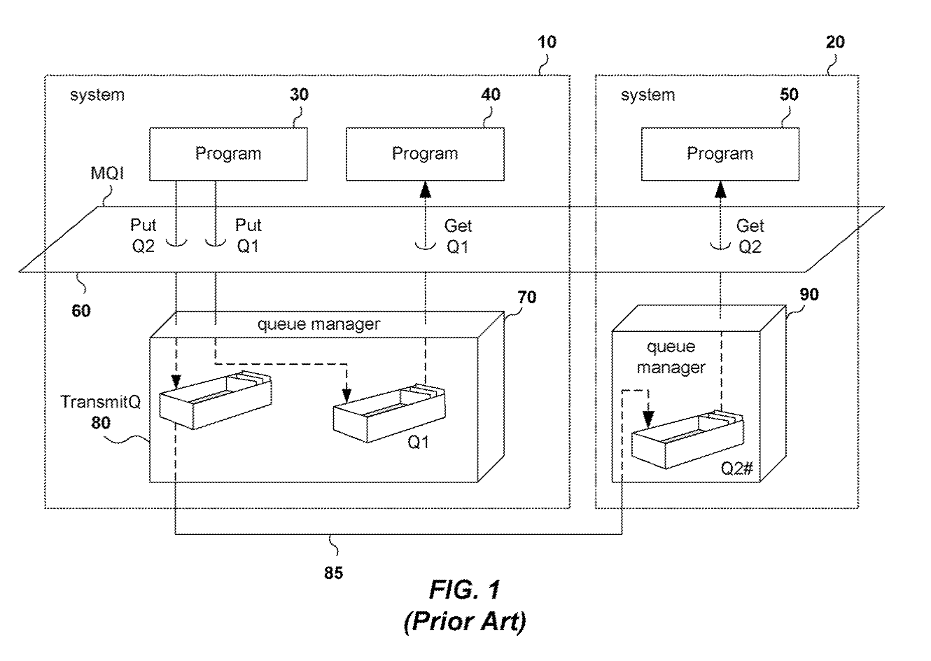

### DETAILED DESCRIPTION

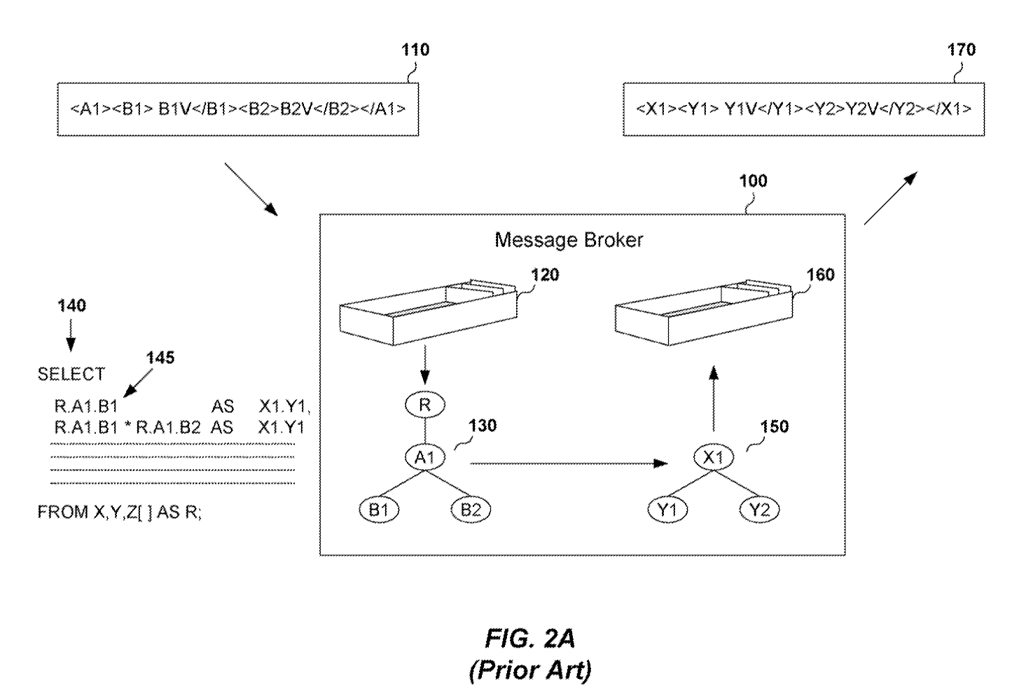

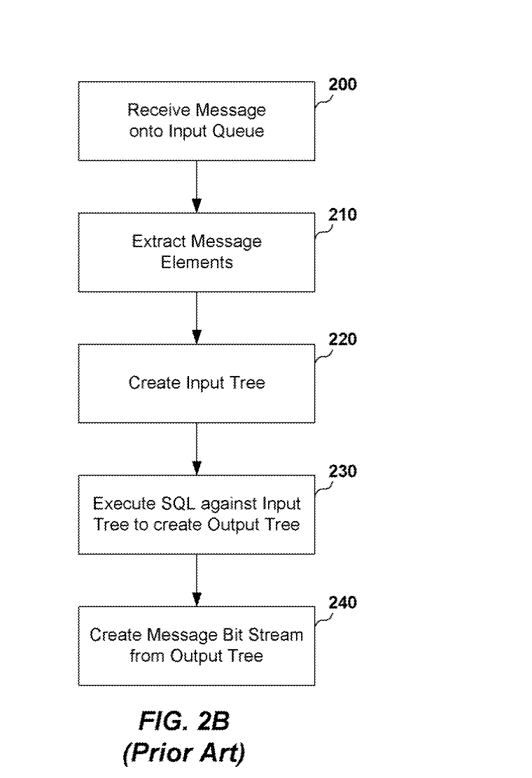

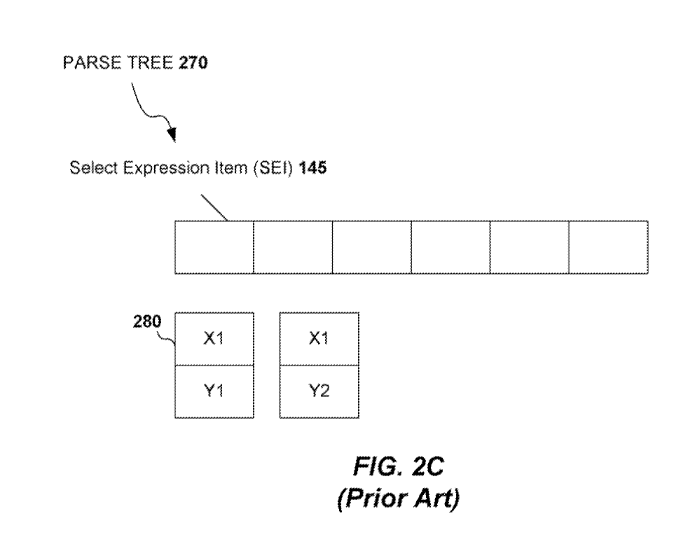

As discussed above, data manipulation can be achieved using a product such as IBM's WebSphere Message Broker product. This is explained in ;more detail with reference to FIGS. 2a, 2b and 2c. These figures should be read in conjunction with one another.

A message 110 is received by message broker 100 and placed onto input queue 120 (step 200). Message 110 may be in the form of XML. From the example given, it can be seen that element A1 encloses elements B1 and B2. Elements B1 and B2 both have values assigned to them B1V and B2V.

Such a message may be manipulated in the form of input and output trees prior to, for example, forward transmission. Thus the elements and their values are extracted from the message (step 210) and used to create an input tree of elements 130 at step 220. Each element comprises a name (e.g. B1) and a value (e.g. B1V). A new input tree is created for each newly received message and discarded once processed.

Such processing may take the form of an SQL query 140, which may be executed against the input tree 130 in order to build output tree 150. In FIG. 2a, an exemplary query is provided. Query 140 comprises a number of selected expressions items (SEI) 145. For example, the first SEI assigns the value of element A1.B1 to element X1.Y1 in an output tree 150. The second SEI multiplies the value in element A1.B1 by the value in element A1.B2 and assigns the resulting value to element X1.Y2 in the output tree. The dotted lines in query 140 signify additional SEIs.

Although not shown (for the sake of simplicity) in example message 110, a message may comprise additional elements and may also comprise repeating elements. Thus the FROM clause in query 140 indicates where the root of the tree is for the purpose of the SELECT statement. In this example the message actually has elements X, Y and Z containing the element A1. Thus X.Y.Z is known within the select statement as root R, and root R has elements A1.B1 and A1.B2 as children. The brackets [] indicate that the element Z and its children may repeat multiple times and that the SELECT processing should be performed on each repetition. Thus R is, in turn, a pointer to each instance of the repeating element Z.

In order to work with the SQL query, an SQL parser breaks the query down into a manageable format (parse tree) thereby allowing an appropriate output tree 150 to be created. The parse tree is created once when the SQL is deployed. This is shown with reference to FIG. 2c.

In parse tree 270, each field in a horizontal row comprises an SEI for query 140. Thus the first field in FIG. 2c comprises the SEI “SELECT R.A1.B1.AS”. The element references which follow the AS command (i.e. references which refer to output tree 150) are placed below the appropriate SEI (e.g. X1 and Y1). Multiple output trees can then be created at runtime using the information stored within the parse tree.

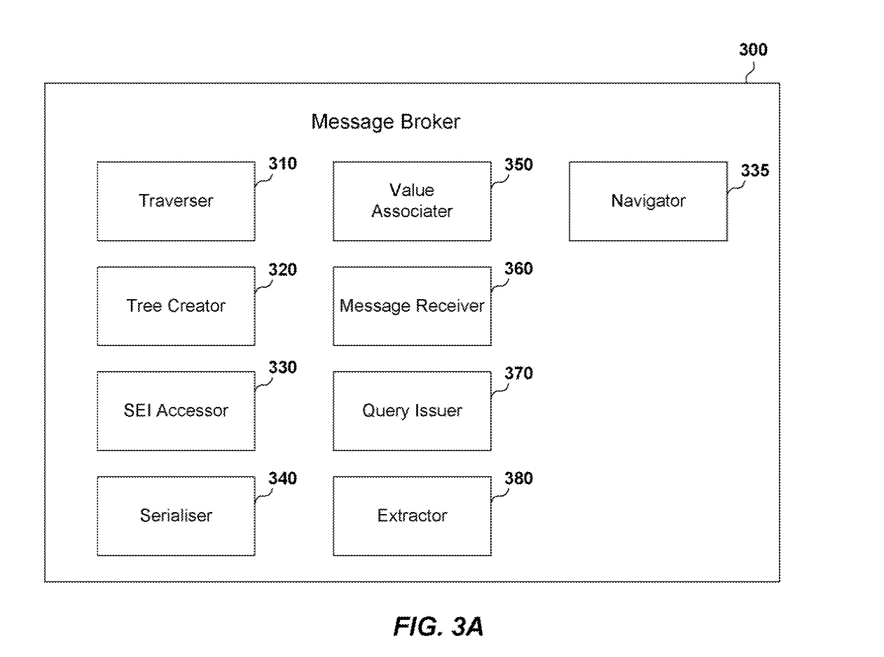

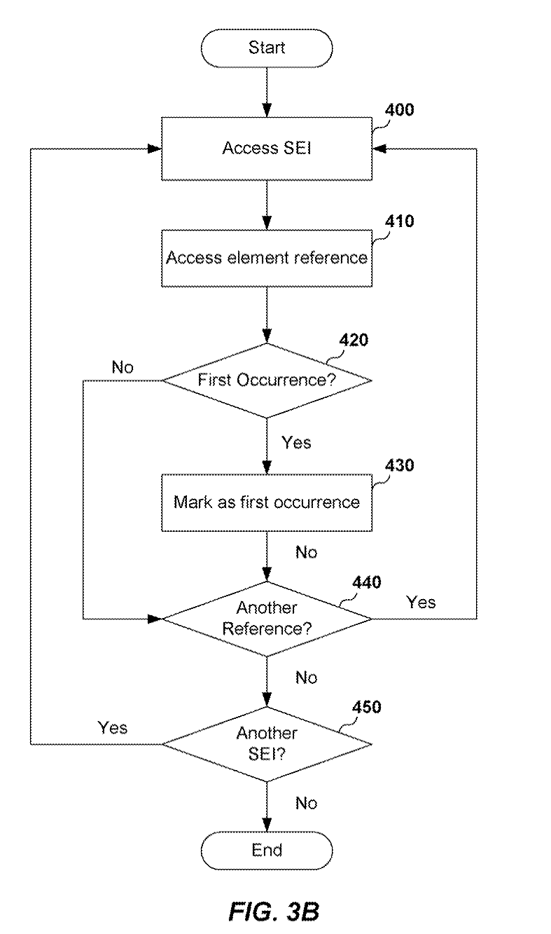

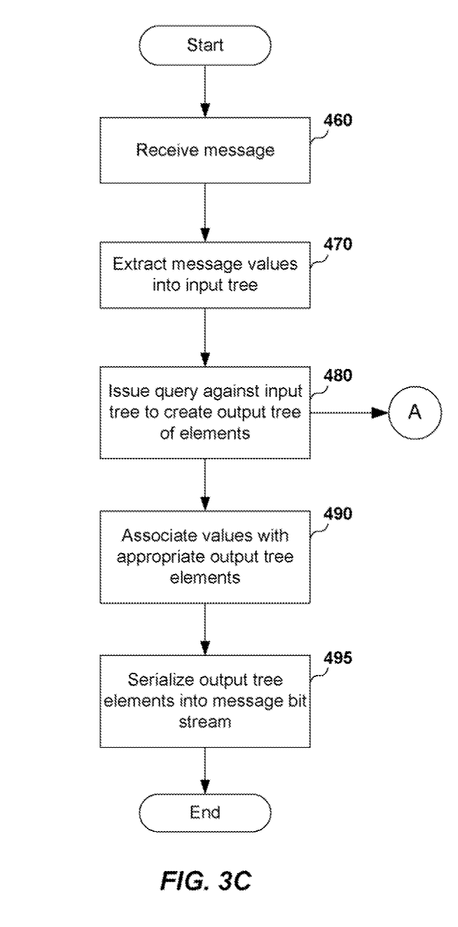

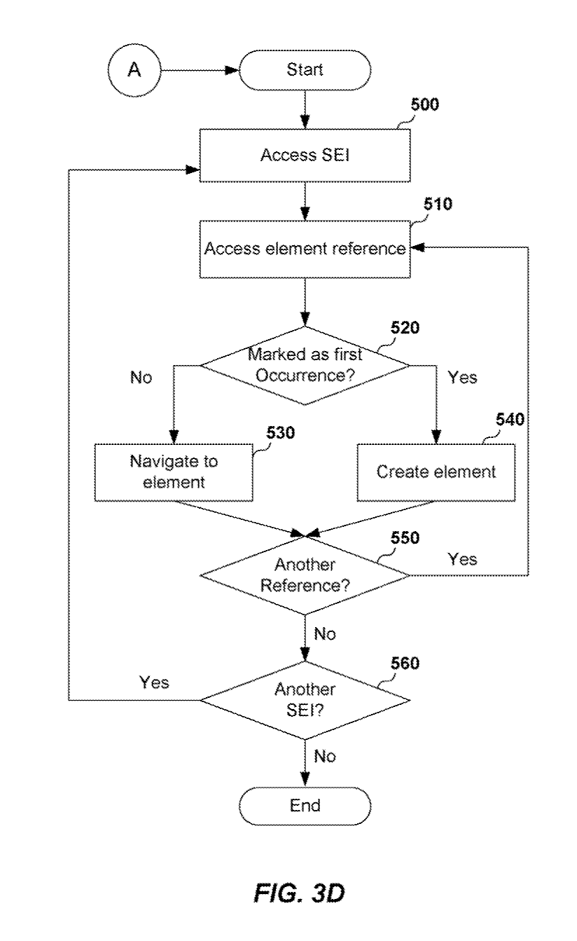

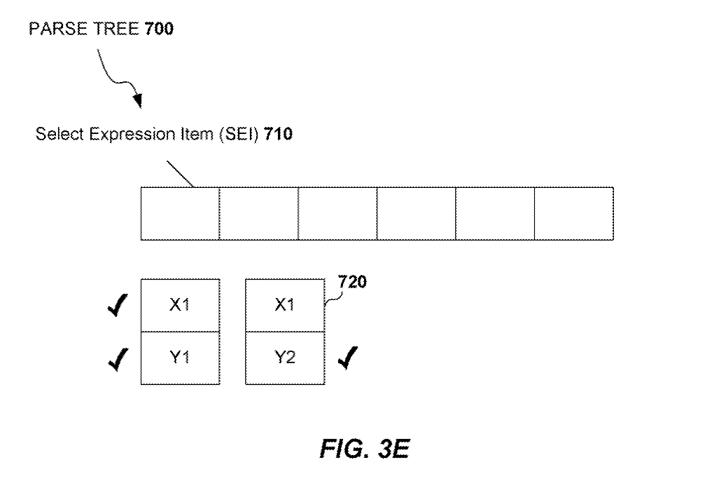

As indicated in the background, the creation of such output trees can be extremely processor intensive as messages can be complex and include may repeating elements. A solution to the aforementioned problem is discussed with reference to FIGS. 3a, 3b, 3c, 3d and 3e. These figures should be read in conjunction with one another.

When an output tree is built, some elements are referred to only once (e.g. Y1 & Y2) but others (e.g. X1) are referred to multiple times. In the previous way of working, all output tree elements were searched for and, if they did not exist, they were then created. This searching was a major consumer of CPU time. When the solution disclosed herein, an analysis of the whole SELECT statement is carried out initially (upon deployment of the database-like expressions) so that those references which are the first reference to any given element can unconditionally create the element thus saving the time taken by a search which is bound to be unsuccessful.

A parse tree is created, as before, upon deployment of database-like expressions to a messaging system. This parse tree 700 is shown with reference to FIG. 3e. Initially the parse tree contains a field 710 for the input part of each SEI which is associated with the output element references 720 for that SEI. Each SEI in the parse tree is accessed in turn by SEI Accessor component 330 (step 400). Each output element reference (720) referenced by the SEI is traversed by Traverser 310 (step 410). It is determined by Traverser 310 whether an element reference is the first occurrence of that element reference (step 420). This can be determined by the Traverser examining all output element references in the parse tree 700 which are in any of the columns to the left of the current column.

If it is determined that this is not the first occurrence, then processing proceeds to step 440 and tests for another element. Note, in order to determine that an element reference (in the current column) has already been referred to, not only must the element reference in a preceding column be identical to the current element reference but so must that element reference's ancestors be identical to the current element reference's ancestors.

If it is determined that this is the first occurrence of an element reference, the processing proceeds to step 430 where the element in the parse tree is marked as such by traverser 310 (step 430). This is shown in FIG. 3e by a tick or check mark. Another element reference in the parse tree is then tested for and either the processing loops round to step 410 again, or the traverser tests whether there is another SEI (step 450). If there is, then processing loops round to step 400. If, on the other hand, the end of the query has been reached, then processing ends.

It should be appreciated that once an element in a column has been marked as being the first occurrence, the traverser can assume that all subsequent element references within that column are also the first occurrence. There is no need to actually perform any kind of check. Either each element reference can be specifically marked or an assumption can be made.

Having marked the element references in parse tree 700 appropriately, such information can be used at runtime to create output trees appropriate to the select expression items.

As alluded to above, the analysis (marking of element references) is preferably carried out upon deployment of the database-like expressions to the messaging system. Of course, such analysis could be carried out prior to deployment.

FIG. 3c illustrates, in accordance with a preferred embodiment, the processing upon receipt of a message at runtime. Each time a new message is received (Message Receiver 360) on an input queue (step 460), the message elements and their associated value are extracted by Extractor 380 in order to create an input tree 130 (step 470). Query issuer 370 then issues the query defined by the parse tree 700 against the input tree in order to create an output tree of elements (step 480). (The detail as to how the output tree is created in the preferred embodiment is discussed with reference to FIG. 3d below.) For each SEI within the query a value is calculated using referenced input tree elements. Such values are then associated with appropriate output tree elements (Value Associater 350) at step 490. Once all SEIs in the SELECT query have been processed, in one embodiment the output tree of elements is serialized into a message bit stream for onward transmission (step 495, Serializer 340).

It should be appreciated however that one transformation may be followed by a subsequent transformation in the same system, in which case serialization is not necessary. The output tree from the first transformation is the input tree to the subsequent transformation.

The creation of the output tree is now described, in accordance with a preferred embodiment, with reference to FIG. 3d. It should be appreciated that, in the preferred embodiment, a new output tree is created for every newly received message and is discarded once processing is finished for that message.

The SEI accessor 330 is used to access each SEI in turn (step 500). For each SEI, the SEI traverser 310 is used to access each element reference in turn (step 510). If an element reference is marked as a first time occurrence (step 520), the corresponding element is created (tree created 320) in the output tree (step 540). If it is not so marked, the field is navigated to (navigator 335) instead (step 530). Previously, the procedure was for all element references to be navigated and, if that failed to find the required element, to create it. The solution disclosed has thus eliminated much of the navigation that was previously necessary.

There is however a possible further optimization. When the SQL has been deployed and the output element messages 720 have been marked as a first reference when appropriate, the further optimization can be applied to each subsequent reference of a first reference by using pointers to elements within the output tree. Pointers to tree elements is well known in the art and so there use herein will be briefly discussed.

An array of pointer variables is created such that there is one pointer variable for each unique subsequent reference. In the case of the example SELECT statement 140, the array would consist of a single variable which would be associated with the references to element X1. Each first reference to an element which is referred to subsequently (so X1 but not Y1 or Y2) is then marked to indicate that, when it is used to create an element in an output tree, the associated pointer variable should be set to point to the newly created element. The output element reference is marked with the index of the variable within the array to enable it to do this. Each subsequent element reference is then removed and the element reference below it is marked to indicate that, when it is used to create an element, the element it creates should be a child of the element pointed to by the appropriate pointer variable. Again the output element reference is marked with the index of the variable within the array to enable it to do this.

The parse tree having been modified in this way, output trees are created in much the same way as described above. Navigation of an output tree is however greatly simplified.

It will be appreciated that whilst the present invention has been described in terms of a messaging system providing data manipulation facilities such as those provided by IBM's Message Broker product, the invention is not limited to such products. The invention is applicable to any data transformation system.

Further the invention has been described in terms of SELECT database-like expressions, however the invention is not limited to such expresionss. Rather the invention is applicable to any descriptive transformation language.

It will be clear to one of ordinary skill in the art that all or part of the method of the preferred embodiments of the preset invention may suitably and usefully be embodied in a logic apparatus, or a plurality of logic apparatus, comprising logic elements arranged to perform the steps of the method and that such logic elements may comprise hardware components, firmware components or a combination thereof.

It will be equally clear to one of skill in the art that all or part of a logic arrangement according to the preferred embodiments of the present invention may suitably be embodied in a logic apparatus comprising logic elements to perform the steps of the method, and that such logic elements may comprise components such as logic gates in, for example a programmable logic array or application-specific integrated circuit. Such a logic arrangement may further be embodied in enabling elements for temporarily or permanently establishing logic structures in such an array or circuit using, for example, a virtual hardware descriptor language, which may be stored and transmitted using fixed or transmittable carrier media.

It will be appreciated that the method and arrangement described above may also suitably be carried out fully or partially in software running on one or more processors (not shown in the figures), and that the software may be provided in the form of one or more computer program elements carried on any suitable data-carrier (also not shown in the figures) such as a magnetic or optical disk or the like. Channels for the transmission of data may likewise comprise storage media of all descriptions as well as signal-carrying media, such as wired or wireless signal-carrying media.

A method is generally conceived to be a self-consistent sequence of steps leading to a desired result. These steps require physical manipulations of physical quantities. Usually, though not necessarily, these quantities take the form of electrical or magnetic signals capable of being stored, transferred, combined, compared, and otherwise manipulated. It is convenient at times, principally for reasons of common usage, to refer to these signals as bits, values, parameters, items, elements, objects, symbols, characters, terms, numbers, or the like. It should be noted, however, that all of these terms and similar terms are to be associated with the appropriate physical quantities and are merely convenient labels applied to these quantities.

The present invention may further suitably be embodied as a computer program product for use with a computer system. Such an implementation may comprise a series of computer-readable instructions either fixed on a tangible medium, such as a computer readable medium, for example, diskette, CD-ROM, ROM, or hard disk, or transmittable to a computer system, via a modem or other interface device, over either a tangible medium, including but not limited to optical or analogue communications lines, or intangibly using wireless techniques, including but not limited to microwave, infrared or other transmission techniques. The series of computer readable instructions embodies all or part of the functionality previously described herein.

Those skilled in the art will appreciate that such computer readable instructions can be written in a number of programming languages for use with many computer architectures or operating systems. Further, such instructions may be stored using any memory technology, present or future, including but not limited to, semiconductor, magnetic, or optical, or transmitted using any communications technology, present or future, including but not limited to optical, infrared, or microwave. It is contemplated that such a computer program product may be distributed as a removable medium with accompanying printed or electronic documentation, for example, shrink-wrapped software, pre-loaded with a computer system, for example, on a system ROM or fixed disk, or distributed from a server or electronic bulletin board over a network, for example, the Internet or World Wide Web.

In one alternative, the preferred embodiment of the present invention may be realized in the form of a computer implemented method of deploying a service comprising steps of deploying computer program code operable to, when deployed into a computer infrastructure and executed thereon, cause said computer system to perform all the steps of the method.

In a further alternative, the preferred embodiment of the present invention may be realized in the form of data carrier having functional data thereon, said functional data comprising functional computer data structures to, when loaded into a computer system and operated upon thereby, enable said computer system to perform all the steps of the method.

It will be clear to one skilled in the art that many improvements and modifications can be made to the foregoing exemplary embodiment without departing from the scope of the present invention.

What is claimed is:

1. A method for data transformation, comprising:
receiving a message;
transforming the message into an input tree of elements, each element have a value associated therewith; and
issuing at least one transformation expression against the input tree in order to create an output tree of elements having values associated therewith, the creation of the output tree of elements comprising using the contents of the at least one transformation expression to determine when an element needs to be created in the output tree.

2. The method of claim 1, wherein a transformation expression comprises a plurality of elements which map to output elements in the output tree.

3. The method of claim 2, further comprising:
analyzing the elements which map to output elements in the output tree for each of a plurality of transformation expressions; and
marking the first occurrence of each unique element within the plurality of transformation expressions.

4. The method of claim 2, wherein the using step comprises determining that an output element needs to be created in the output tree when such an element results from the first occurrence of a unique element within the plurality of transformation expressions.

5. The method of claim 4, further comprising determining that an output element will already exist in the output tree when such an element results from a subsequent occurrence of a unique element within the plurality of transformation expressions.

6. The method of claim 1, further comprising creating the output element responsive to determining that an output element needs to be created in the output tree.

7. The method of claim 1, further comprising navigating to the output element by tree traversal, responsive to determining that an output element does not need to be created in the output tree.

8. The method of claim 1, further comprising accessing the element by reference, responsive to determining that an output element does not need to be created in the output tree.

9. Apparatus for data transformation, comprising:
a receiving component for receiving a message;
a transforming component for transforming the message into an input tree of elements, each element having a value associated therewith; and
an issuing component for issuing at least one transformation expression against the input tree in order to create an output tree of elements having values associated therewith, the creation of the output tree of elements being via a using component for using the contents of the at least one transformation expression to determine when an element needs to be created in the output tree.

10. The method of claim 9, wherein a transformation expression comprises a plurality of elements which map to output elements in the output tree.

11. The method of claim 10, further comprising:
an analyzing component for analyzing the elements which map to output elements in the output tree for each of a plurality of transformation expressions; and
a marking component for marking the first occurrence of each unique element within the plurality of transformation expressions.

12. The apparatus of claim 10, wherein the using component comprises a determining component for determining that an output element needs to be created in the output tree when such an element results from the first occurrence of a unique element within the plurality of transformation expressions.

13. The apparatus of claim 12, further comprising a determining component for determining that an output element will already exist in the output tree when such an element results from a subsequent occurrence of a unique element within the plurality of transformation expressions.

14. The apparatus of claim 9, further comprising a creating component for creating the output element, responsive to determining that an output element needs to be created in the output tree.

15. The apparatus of claim 9, further comprising a navigating component for navigating to the output element by tree traversal, responsive to determining that an output element does not need to be created in the output tree.

16. The apparatus of claim 9, further comprising an accessing component for accessing the element by reference, responsive to determining that an output element does not need to be created in the output tree.

17. A computer program product to transform data, the computer program product comprising a computer-usable medium having computer-usable program code embedded therewith, the computer usable medium comprising:
computer-usable program code configured to receive a message;
computer-usable program code configured to transform the message into an input tree of elements, each element having a value associated therewith; and
computer-usable program code configured to issue at least one transformation expression against the input tree in order to create an output tree of elements having values associated therewith, the creation of the output tree of elements being via computer-usable program code configured to use the contents of the at least one transformation expression to determine when an element needs to be created in the output tree.

18. The computer program product of claim 17, wherein a transformation expression comprises a plurality of elements which map to output elements in the output tree.

19. The computer program product of claim 18, further comprising:
computer-usable program code configured to analyze the elements which map to output elements in the output tree for each of a plurality of transformation expressions; and
computer-usable program code configured to mark the first occurrence of each unique element within the plurality of transformation expressions.

20. The computer program product of claim 18, wherein the computer-usable program code configured to use the contents of the at least one transformation expression to determine when an element needs to be created in the output tree comprises computer-usable program code configured to determine that an output element needs to be created in the output tree when such an element results from the first occurrence of a unique element within the plurality of transformation expressions.

21. The computer program product of claim 20, further comprising computer-usable program code configured to determine that an output element will already exist in the output tree when such an element results from a subsequent occurrence of a unique element within the plurality of transformation expressions.

22. The computer program product of claim 17, further comprising computer-usable program code configured to create the output element, responsive to determining that an output element needs to be created in the output tree.

23. The computer program product of claim 17, further comprising computer-usable program code configured to navigate the output element by tree traversal, responsive to determining that an output element does not need to be created in the output tree.

24. The computer program product of claim 17, further comprising computer-usable program code configured to access the element by reference responsive to determining that an output element does not need to be created in the output tree.
